(19) United States
(12) Patent Application Publication
(10) Pub. No.: US 2009/0124738 A1
(43) Pub. Date: May 14, 2009

(54) Rubber Composition And Pneumatic Tire

(75) Inventors: Takashi Sakurai, Osaka (JP); Hirofumi Hayashi, Osaka (JP)

Correspondence Address: FISH & RICHARDSON P.C., P.O. BOX 1022, MINNEAPOLIS, MN, 55440-1022, US

(73) Assignee: Toyo Tire & Rubber Co., Ltd., Osaka (JP)

(21) Appl. No.: 12/265,855

(22) Filed: Nov. 6, 2008

(30) Foreign Application Priority Data
Nov. 14, 2007 (JP) 2007-295143

(51) Int. Cl. C08K 5/09; C08K 3/34; C08L 9/00

(52) U.S. Cl. 524/300

(57) ABSTRACT

A rubber composition that can improve rolling resistance of a tire without impairing other performances such as processability or wet performance, and a pneumatic tire using the same are provided. The rubber composition includes a diene rubber as a rubber component, and clay treated with a fatty acid.

### CROSS-REFERENCE TO RELATED APPLICATIONS

This application is based upon and claims the benefit of priority from the prior Japanese Patent Application No. 2007-295143, filed on Nov. 14, 2007; the entire contents of which are incorporated herein by reference.

### BACKGROUND

The present invention relates to a rubber composition having clay dispersed therein. More particularly, it relates to a rubber composition that improves rolling resistance of a tire without impairing processability or wet performance, by improving dispersibility of clay.

For example, a rubber composition used in a tread of a pneumatic tire is strongly required to reduce rolling resistance from market needs of low fuel consumption, and furthermore is required that each rubber characteristic such as improvement of wet performance or driveability (grip performance) and excellent abrasion resistance from the points of durability and economic efficiency is balanced.

Reinforcing filler such as carbon black, silica or clay has conventionally been compounded with and used in a rubber composition. It is indispensable to make each rubber characteristic be balanced that those fillers are uniformly dispersed in a rubber composition.

Various proposals such as carbon black surface-treated with a silane compound having an amino group are made as materials to improve dispersibility of carbon black and silica (see, for example, JP-A-9-87612).

Clay treated with an aminosilane type coupling agent is disclosed as a material to uniformly disperse clay in a rubber composition, but its object is to provide a gas shielding rubber composition (JP-A-2003-292677).

### SUMMARY

The present invention has objects to provide a rubber composition that can improve rolling resistance of a tire without impairing other performances such as processability or wet performance, by improving dispersibility of clay, and a pneumatic tire using the same.

As a result of earnest investigations to overcome the above problems, it has been found that clay surface is modified by surface-treating the clay with a fatty acid, thereby dispersibility of the clay in a rubber can be improved, and this makes it possible to modify properties of a rubber composition.

Accordingly, the present invention provides a rubber composition comprising a diene rubber as a rubber component, and clay treated with a fatty acid.

In the preferred embodiment of the invention, an amount of the fatty acid deposited is from 0.1 to 20% by weight based on the weight of untreated clay, and the clay treated with a fatty acid is contained in an amount of from 1 to 100 parts by weight per 100 parts by weight of the rubber component.

The present invention further provides a pneumatic tire using the rubber composition in at least a part of a tire.

According to the present invention, dispersibility of clay is improved by the action of a fatty acid deposited on the surface of clay, thereby improving rubber properties of a rubber composition. As a result, rolling resistance of a tire is improved without impairing other performances such as processability or wet properties, and fuel consumption of a pneumatic tire is reduced. Furthermore, a tire reducing environmental load and giving consideration to environment can be provided by using clay and a fatty acid as natural products.

### DETAILED DESCRIPTION

The embodiment of the present invention is described below.

The rubber composition of the present invention uses a diene rubber as a rubber component. The diene rubber includes a natural rubber (NR), an epoxidized natural rubber (ENR) and a diene synthetic rubber. Examples of the diene synthetic rubber include a styrene-butadiene rubber (SBR), a polybutadiene rubber (BR), a polyisoprene rubber (IR), an ethylene-propylene-diene rubber (EPDM), a chloroprene rubber (CR) and an acrylonitrile-butadiene rubber (NBR). Those diene rubbers may be used alone or as mixtures of two or more thereof.

The clay preferably used in the present invention has an average particle diameter of 10 μm or less. Where the average particle diameter exceeds 10 μm, reinforcing effect is not sufficiently exhibited, and abrasion resistance tends to be decreased. On the other hand, where the average particle diameter is too small, agglomeration between particles is strong, making it difficult to well disperse the clay in a rubber component, and there is the case that a rubber composition having the desired performances is not obtained. It is desired from the standpoint of balance in reinforcing property, wet performance and rolling resistance that the clay is fine particles having the average particle diameter of 2 μm or less, and preferably from 0.01 to 1 μm. Examples of a clay mineral include kaolinite, halloysite, montmorilonite, illite and vermiculite. Those clay minerals may be used alone or as mixtures of two or more thereof.

In the present invention, the fatty acid used to treat the clay may be a saturated fatty acid or an unsaturated fatty acid. Furthermore, the fatty acid may be a linear fatty acid, a branched fatty acid or derivatives of a fatty acid.

The fatty acid is preferably a higher fatty acid having from 4 to 24 carbon atoms. Where the carbon atom number is less than 6, bleeding tends to be liable to be generated when blended with a rubber. Where the carbon atom number exceeds 20, processability tends to be decreased. Furthermore, it is difficult to obtain inexpensively. In particular, a fatty acid having from 8 to 18 carbon atoms is preferred.

Specific examples of the saturated fatty acid include butyric acid, valeric acid, caproic acid, enanthic acid, caprylic acid, pelargonic acid, capric acid, myristic acid, pentadecylic acid, palmitic acid, heptadecanoic acid and stearic acid.

Specific examples of the unsaturated fatty acid include oleic acid, maleic acid, linoleic acid and linolenic acid.

Examples of the derivatives of a fatty acid include fatty acid metal salts, fatty acid esters and fatty acid amides. Examples of the fatty acid metal salt include barium stearate, calcium stearate, magnesium stearate and zinc stearate. Examples of the fatty acid ester include higher alcohol fatty acid ester and polyethylene glycol alkyl ester. Examples of the fatty acid amide include unsaturated fatty acid amides such as oleic amide or erucic amide, and saturated fatty acid amides such as stearic amide or behenic amide.

Examples of the branched fatty acid include isohexanoic acid, isoheptanoic acid, 2-ethylhexanoic acid, isononanoic acid, isodecanoic acid, isotridecanoic acid, isomyristic acid and isopalmitic acid.

Above all, the fatty acid is preferably stearic acid, linoleic acid and oleic acid. Stearic acid is particularly preferred. The above various fatty acids may be used alone or as mixtures of two or more thereof.

In the present invention, an amount of the fatty acid deposited by the treatment is preferably from 0.1 to 20% by weight based on the weight of untreated clay. Where the deposition amount is less than 0.1% by weight, an effect of improving dispersibility of clay is not obtained, and where the amount exceeds 20% by weight, further effect cannot be expected.

The treatment method of the clay with the fatty acid is not particularly limited. Examples of the treatment method include a method of mixing a powder of a fatty acid and clay, a method of heating the mixture, and a method of spraying a fatty acid solution to clay and drying.

The amount of the treated clay compounded with the rubber composition is from 1 to 100 parts by weight, and preferably from 5 to 70 parts by weight, per 100 parts by weight of the rubber component. Where the compounding amount is less than 1 part by weight, an effect of improving processability and rolling resistance is small, and where the amount exceeds 100 parts by weight, processability deteriorates due to rise of rubber hardness, and decrease of abrasion resistance is observed.

In the rubber composition of the present invention, a reinforcing agent such as carbon black or silica can be used together with the clay, and carbon black and silica may be used in combination.

The carbon black is not particularly limited. For example, carbon black having colloidal properties that a BET specific surface area (BET) is from 25 to 130 m²/g and a DBP absorption is 80 ml/100 g or more can be used. The BET and the DBP absorption are measured according to a method described in JIS K6217.

Examples of such a carbon black include various grades of N110, N220, N330, N550 and N660 in ASTM number.

The compounding amount of the carbon black is from about 0 to 150 parts by weight per 100 parts by weight of the rubber component. Where the compounding amount of the carbon black exceeds 150 parts by weight, heat build-up deteriorates and processability is decreased.

For example, silica having colloidal properties that BET is 150 m²/g or less and DBP absorption is 190 ml/100 g or less is preferred as the silica. By using silica having such a large particle diameter and small structure, processability can be maintained, and additionally, heat build-up can be suppressed and rolling resistance can be reduced.

The compounding amount of the silica is from about 20 to 120 parts by weight per 100 parts by weight of the rubber component. Where the compounding amount of the silica is less than 20 parts by weight, an effect of reducing rolling resistance cannot sufficiently be exhibited.

The silica is not particularly limited so long as the above colloidal properties are satisfied. Examples of the silica include wet silica (hydrous silicic acid), dry silica (anhydrous silicic acid), calcium silicate and aluminum silicate. Of those, wet silica combining fracture characteristic and low rolling resistance is preferred, and is also preferred from the point of excellent productivity. Commercially available products such as NIPSIL AQ and VN3, manufactured by Tosoh Silica Corporation, PR and USG-A, manufactured by Tokuyama Corp., or ULTRASIL VN3, manufactured by Degussa can be used. The BET is measured according to a BET method described in ISO 5794, and the DBP absorption is measured according to a method described in JIS K6221.

A surface-treated silica surface-treated with amines or organic polymers to improve affinity with a polymer may be used as the silica.

When the silica is used, a silane coupling agent is preferably used in an amount of from 2 to 20% by weight based on the weight of the silica. More preferably, the silane coupling agent is used in an amount of from 2 to 15% by weight. Examples of the silane coupling agent include sulfur-containing silane coupling agents such as bis(3-triethoxysilylpropyl)tetrasulfide or bis(3-triethoxysilylpropyl)disulfide, and protected mercaptosilanes represented by the following formula (I)

(CₓH₂ₓ₊₁O)₃Si—(CH₂)_{y}—S—CO—C_{z}H_{2z+1} (1)

wherein x is an integer of from 1 to 3, y is an integer of from 1 to 5, and z is an integer of from 5 to 9.

The compounding amount of the carbon black and silica can be reduced by substituting with the compounding amount of the clay. In particular, in the case of silica, the amount of the silane coupling agent corresponding to the reduced amount of the silica can be reduced, and this can contribute to cost reduction of a rubber composition.

Various compounding ingredients such as process oils, zinc white, stearic acid, waxes, age resisters, vulcanizing agents, vulcanization accelerators, vulcanization aids or resins, that are generally used in tire industries can be compounded with and used in the rubber composition of the present invention in a range that the advantage of the present invention is not impaired, according to need.

The rubber composition of the present invention can be prepared by compounding various compounding ingredients with a starting rubber and clay treated with a fatty acid and using various kneading machines such as Banbury mixer, rolls or a kneader, according to the conventional method, and can be used in each site of a tire, such as a side wall or a bead, including a tread of a tire.

### EXAMPLES

The present invention is described using the following Examples, but the invention is not limited by those Examples.

### Preparation of Fatty Acid-Treated Clay

A 10 wt % aqueous solution of stearic acid (RUNAX S-20, manufactured by Kao Corporation) was sprayed to clay (kaolin clay, manufactured by THIELE) to obtain fatty acid-treaded clays having a deposition amount of 1% by weight (treated clay 1), 10% by weight (treated clay 2) and 20% by weight (treated clay 3). As Comparative Examples, aminosilane-treated clay (ST-301, manufactured by Shiraishi Calcium Kaisha, Ltd., treated clay 4) and mercaptosilane-treated clay (ST-309, manufactured by Shiraishi Calcium Kaisha, Ltd., treated clay 5) were used.

### Preparation of Rubber Composition

Using Banbury mixer having a volume of 20 liters, rubber compositions were prepared according to the formulations shown in Tables 1 to 4 below. Each component in Tables 1 to 4 and the common compounding ingredients are as follows. Table 1 is the formulation for tread (SBR/BR compounding system), Table 2 is the formulation for side wall (NR/BR compounding system and NR compounding system), Table 3 is the formulation for tread (NR/ENR compounding system) and Table 4 is the formulation for tread (NR compounding system).

### Rubber Component

Natural rubber (NR): RSS#3, made in Malaysia

Styrene-butadiene rubber (SBR): TUFDENE E-50, manufactured by Asahi Kasei Corporation

Butadiene rubber (BR): BR01, manufactured by JSR Corporation.

Epoxidized natural rubber (ENR): 25 mol % epoxidized natural rubber EPOXY PRENE 25, manufactured by MMG

### Common Compounding Ingredients

Silica: NIPSIL AQ, manufactured by Tosoh Silica Corporation

Silane coupling agent: Si-69, manufactured by Degussa

Carbon black: SHOW BLACK N330, manufactured by Cabot Japan

Zinc white: Zinc White #1, manufactured by Mitsui Mining & Smelting Co., Ltd.

Stearic acid: RUNAX S-20, manufactured by Kao Corporation

Aroma oil: PROCESS X-140, manufactured by Japan Energy Corporation

Age resister 6C: SANTOFLEX 6PPD, manufactured by FLEXSYS

Wax: OZOACE 0355, manufactured by Nippon Seiro Co., Ltd.

Sulfur: Powdery sulfur for rubber 150 mesh, manufactured by Hosoi Chemical Industry Co., Ltd.

Vulcanization accelerator CZ: NOCCELLAR CZ-G, manufactured by Ouchi Shinko Chemical Industrial Co., Ltd.

### Evaluation

Processability of each rubber composition obtained was evaluated by Mooney viscosity. Tires (Tables 1, 3 and 4) in which each rubber composition was applied to a tread, and a tire (Table 2) in which each rubber composition was applied to a side wall, each tire being a radial tire having a size of 205/65R15 94H, were produced according to the conventional method. Rolling resistance properties and wet performance (braking performance) of each tire were evaluated. Each evaluation method is as follows. The results obtained are shown in Tables 1 to 4.

### Processability

Mooney viscosity (ML₁₊₄) of a rubber composition was measured at 100° C. according to JIS K6300. The processability was indicated by an index as the values of Comparative Example 1, Comparative Example 6, Comparative Example 10 and Comparative Example 13 in each Table being 100. Viscosity is low and processability is good as the index is small.

### Rolling Resistance Properties

A tire was mounted using a rim of 15×6.5JJ. Rolling resistance was measured when running 80 km/hr at 23° C. by a uniaxial drum tester for rolling resistance measurement with air pressure of 230 kPa and a load of 450 kgf. The rolling resistance was indicated by an index as the values of Comparative Example 1, Comparative Example 6, Comparative Example 10 and Comparative Example 13 in each Table being 100. Rolling resistance is small and therefore fuel consumption efficiency is excellent as the index is small.

### Wet Performance

Four radial tires obtained above were used in a 2000 cc front-wheel-drive domestic car, and the car was run on an asphalt road surface on which water was sprayed in a depth of 2 to 3 mm. ABS was operated at 90 km per hour, and a braking distance until reaching a reduced speed of 20 km/hr was measured. The wet performance was indicated by an index as the values of Comparative Example 1, Comparative Example 6, Comparative Example 10 and Comparative Example 13 in each Table being 100. The wet performance is excellent as the index is large.

TABLE 1

| | Comparative | Comparative | Comparative | Comparative | Comparative | | | | |
|---|---|---|---|---|---|---|---|---|---|
| | Example 1 | Example 2 | Example 3 | Example 4 | Example 5 | Example 1 | Example 2 | Example 3 | Example 4 |
| SBR | 65 | 65 | 65 | 65 | 65 | 65 | 65 | 65 | 65 |
| BR | 35 | 35 | 35 | 35 | 35 | 35 | 35 | 35 | 35 |
| Untreated clay | | 15 | | | | | | | |
| Treated clay 1 | | | | | | 15 | 30 | | |
| Treated clay 2 | | | | | | | | 15 | |
| Treated clay 3 | | | | | | | | | 15 |
| Treated clay 4 | | | 15 | | | | | | |
| Treated clay 5 | | | | 15 | | | | | |
| Silica | 80 | 80 | 80 | 80 | 80 | 80 | 80 | 80 | 80 |
| Silane coupling | 6.4 | 6.4 | 6.4 | 6.4 | 6.4 | 6.4 | 6.4 | 6.4 | 6.4 |
| agent | | | | | | | | | |
| Carbon black | 5 | 5 | 5 | 5 | 5 | 5 | 5 | 5 | 5 |
| Zinc white | 2 | 2 | 2 | 2 | 2 | 2 | 2 | 2 | 2 |
| Stearic acid | 2 | 2 | 2 | 2 | 4 | 2 | 2 | 2 | 2 |
| Oil | 40 | 40 | 40 | 40 | 40 | 40 | 40 | 40 | 40 |
| Age resister | 2 | 2 | 2 | 2 | 2 | 2 | 2 | 2 | 2 |
| Wax | 2 | 2 | 2 | 2 | 2 | 2 | 2 | 2 | 2 |
| Sulfur | 2 | 2 | 2 | 2 | 2 | 2 | 2 | 2 | 2 |
| Vulcanization | 2 | 2 | 2 | 2 | 2 | 2 | 2 | 2 | 2 |
| accelerator | | | | | | | | | |
| Processability | 100 | 105 | 117 | 90 | 97 | 100 | 95 | 90 | 88 |
| (Index) | | | | | | | | | |
| Rolling resistance | 100 | 99 | 101 | 100 | 100 | 97 | 96 | 93 | 92 |
| (Index) | | | | | | | | | |
| Wet performance | 100 | 99 | 100 | 95 | 100 | 100 | 98 | 99 | 100 |
| (Index) | | | | | | | | | |

TABLE 2

| | Comparative | Comparative | Comparative | Comparative | | | | |
|---|---|---|---|---|---|---|---|---|
| | Example 6 | Example 7 | Example 8 | Example 9 | Example 5 | Example 6 | Example 7 | Example 8 |
| NR | 60 | 60 | 60 | 60 | 60 | 60 | 100 | 100 |
| BR | 40 | 40 | 40 | 40 | 40 | 40 | | |
| Untreated clay | | 15 | | | | | | |
| Treated clay 1 | | | | | 15 | | | |
| Treated clay 2 | | | | | | 15 | 15 | |
| Treated clay 3 | | | | | | | | 15 |
| Treated clay 4 | | | 15 | | | | | |
| Treated clay 5 | | | | 15 | | | | |
| Carbon black | 40 | 40 | 40 | 40 | 40 | 40 | 40 | 40 |
| Zinc white | 2 | 2 | 2 | 2 | 2 | 2 | 2 | 2 |
| stearic acid | 2 | 2 | 2 | 2 | 2 | 2 | 2 | 2 |
| age resister | 2 | 2 | 2 | 2 | 2 | 2 | 2 | 2 |
| Wax | 1 | 1 | 1 | 1 | 1 | 1 | 1 | 1 |
| Sulfur | 1.5 | 1.5 | 1.5 | 1.5 | 1.5 | 1.5 | 1.5 | 1.5 |
| Vulcanization | 1 | 1 | 1 | 1 | 1 | 1 | 1 | 1 |
| accelerator | | | | | | | | |
| Processability | 100 | 108 | 108 | 110 | 100 | 88 | 90 | 84 |
| (Index) | | | | | | | | |
| Rolling resistance | 100 | 98 | 103 | 102 | 97 | 93 | 95 | 91 |
| (Index) | | | | | | | | |

TABLE 3

| | Comparative | Comparative | Comparative | | | | |
|---|---|---|---|---|---|---|---|
| | Example 10 | Example 11 | Example 12 | Example 9 | Example 10 | Example 11 | Example 12 |
| NR | 60 | 60 | 60 | 60 | 60 | 40 | 60 |
| ENR | 40 | 40 | 40 | 40 | 40 | 60 | 40 |
| Untreated clay | | 15 | | | | | |
| Treated clay 1 | | | | 15 | | | |
| Treated clay 2 | | | | | 15 | 15 | |
| Treated clay 3 | | | | | | | 15 |
| Treated clay 4 | | | 15 | | | | |
| Silica | 80 | 80 | 80 | 80 | 80 | 80 | 80 |
| Silane coupling | 6.4 | 6.4 | 6.4 | 6.4 | 6.4 | 6.4 | 6.4 |
| agent | | | | | | | |
| Carbon black | 5 | 5 | 5 | 5 | 5 | 5 | 5 |
| Zinc white | 2 | 2 | 2 | 2 | 2 | 2 | 2 |
| Stearic acid | 2 | 2 | 2 | 2 | 2 | 2 | 2 |
| Oil | 15 | 15 | 15 | 15 | 15 | 15 | 15 |
| Age resister | 2 | 2 | 2 | 2 | 2 | 2 | 2 |
| Wax | 2 | 2 | 2 | 2 | 2 | 2 | 2 |
| Sulfur | 2 | 2 | 2 | 2 | 2 | 2 | 2 |
| Vulcanization | 2 | 2 | 2 | 2 | 2 | 2 | 2 |
| accelerator | | | | | | | |
| Processability | 100 | 104 | 106 | 100 | 90 | 90 | 86 |
| (Index) | | | | | | | |
| Rolling resistance | 100 | 98 | 102 | 97 | 93 | 94 | 90 |
| (Index) | | | | | | | |
| Wet performance | 100 | 100 | 100 | 102 | 103 | 105 | 104 |
| (Index) | | | | | | | |

TABLE 4

| | Comparative | Comparative | Example | Example |
|---|---|---|---|---|
| | Example 13 | Example 14 | 13 | 14 |
| NR | 100 | 100 | 100 | 100 |
| Untreated clay | | 15 | | |
| Treated clay 2 | | | 15 | |
| Treated clay 3 | | | | 15 |
| Silica | 80 | 80 | 80 | 80 |
| Silane coupling | 6.4 | 6.4 | 6.4 | 6.4 |
| agent | | | | |
| Carbon black | 5 | 5 | 5 | 5 |
| Zinc white | 2 | 2 | 2 | 2 |
| Stearic acid | 2 | 2 | 2 | 2 |
| Oil | 15 | 15 | 15 | 15 |
| Age resister | 2 | 2 | 2 | 2 |
| Wax | 2 | 2 | 2 | 2 |
| Sulfur | 2 | 2 | 2 | 2 |
| Vulcanization | 2 | 2 | 2 | 2 |
| accelerator | | | | |
| Processability | 100 | 102 | 96 | 93 |
| (Index) | | | | |
| Rolling resistance | 100 | 99 | 94 | 91 |
| (Index) | | | | |
| Wet performance | 100 | 100 | 101 | 100 |
| (Index) | | | | |

As described above, the rubber composition of the present invention is used in each site of a tire such as a side wall or a bead, including a tread of a tire, and can provide a pneumatic tire which particularly reduces rolling resistance and decreases fuel consumption.

What is claimed is:

1. A rubber composition comprising a diene rubber as a rubber component, and clay treated with a fatty acid.

2. The rubber composition as claimed in claim 1, wherein an amount of the fatty acid deposited is from 0.1 to 20% by weight based on the weight of untreated clay.

3. The rubber composition as claimed in claim 1, wherein the clay treated with a fatty acid is contained in an amount of from 1 to 100 parts by weight per 100 parts by weight of the rubber component.

4. A pneumatic tire using the rubber composition as claimed claim 1 in at least a part of a tire.

5. A pneumatic tire using the rubber composition as claimed claim 2 in at least a part of a tire.

6. A pneumatic tire using the rubber composition as claimed claim 3 in at least a part of a tire.
